(19) United States
(12) Patent Application Publication
(10) Pub. No.: US 2019/0073893 A1
(43) Pub. Date: Mar. 7, 2019

(54) PORTABLE ELECTRONIC DEVICE COMPRISING MEANS FOR EMITTING AN ALARM SIGNAL

(71) Applicant: Skygates S.r.l., Dorno (PV) (IT)

(72) Inventor: Paolo Giuseppe CARDILLO, Desenzano Del Garda (BS) (IT)

(73) Assignee: Skygates S.R.L., Dorno (PV) (IT)

(21) Appl. No.: 16/081,051

(22) PCT Filed: Feb. 22, 2017
(86) PCT No.: PCT/IT2017/000033

§ 371 Date: Aug. 30, 2018

(30) Foreign Application Priority Data
Mar. 10, 2016 (IT) 102016000025054

(51) Int. Cl. G08B 25/01; H04W 4/02; H04W 8/18

(52) U.S. Cl. CPC G08B 25/016; H04W 4/80; H04W 8/183; H04W 4/025

(57) ABSTRACT

The invention relates to a portable device comprising at least one button for sending an alarm signal. The latter is encoded into radio frequency electromagnetic waves and sent, by means of an appropriate antenna, to a portable electronic apparatus, such as, for example, a smartphone. The connection between the latter and the device of the invention takes place, for example, by means of Bluetooth™ technology or by means of a cellular mobile network. In this second case, the device of the invention, like a mobile phone or a smartphone, is preferably equipped with a SIM card by means of which it may connect to the Internet network. The device of the invention may comprise a geolocator for determining the geographical position thereof, preferably by means of GPS technology. In this case, when the aforesaid button is pressed, the geolocator acquires the geographical position of the device of the invention. This information is then encoded into electromagnetic waves and included in the alarm signal transmitted by the antenna. Finally, the device of the invention comprises a safety cap to prevent the aforesaid button from being inadvertently pressed.

### FIELD OF APPLICATION OF THE INVENTION

The present invention relates to the field of self-defense devices, and more precisely to a portable electronic device equipped with means for emitting an alarm signal.

Here and in the description below, “portable” device (or apparatus) means a device which is sufficiently compact to ensure that the use thereof does not place restrictions on the mobility of a user of the device.

### REVIEW OF THE PRIOR ART

Self-defense is generally associated with the use of weapons and/or physical fighting techniques. Thereby, however, the possibility to defend oneself is not within the reach of all but only of those who are specifically capable of preparing for defense, by means of tools and/or techniques adapted to the purpose.

In the light of the above considerations, the need to have a device for sending, if needed, an alarm signal irrespective of the place, time and situation in which a person finds himself/herself is strongly felt. A similar need may arise, by way of example, in case of illness or aggression by a wrongdoer. It is apparent that in these cases the person may not be able to speak or text or choose and dial the correct sequence of keys on a portable device, such as a mobile phone, for example.

### OBJECTS OF THE INVENTION

It is the object of the present invention to overcome the aforesaid drawback and meet such a need by providing a portable device provided with components by means of which, in case of need, a person holding it may send an alarm signal.

### SUMMARY OF THE INVENTION

The present invention relates to a portable device comprising:
means for emitting an alarm signal;
means for activating the aforesaid emitting means by a person holding the device.

Portable devices are items that a person, when leaving home, may easily carry.

Therefore, the advantage of having a portable device capable of emitting an alarm signal in case of need is apparent.

Other innovative features of the present invention are described in the dependent claims.

### BRIEF DESCRIPTION OF THE DRAWINGS

Further objects and advantages of the present invention will become apparent from the following detailed description of an embodiment thereof and from the accompanying drawings, merely given by way of explanation and not by way of limitation, in which:

FIG. 1 shows a perspective view of a device according to the present invention where a safety cap prevents the means for emitting an alarm signal from being accidentally activated;

FIG. 2 shows a perspective view of the device in FIG. 1 with the safety cap rotated so as to allow the means for emitting the alarm signal to be activated.

### DETAILED DESCRIPTION OF CERTAIN PREFERRED EMBODIMENTS OF THE INVENTION

In the continuation of the present description, a figure may also be shown with reference to elements not expressly indicated in that figure but in other figures. The scale and proportions of the various elements depicted do not necessarily correspond to the real ones.

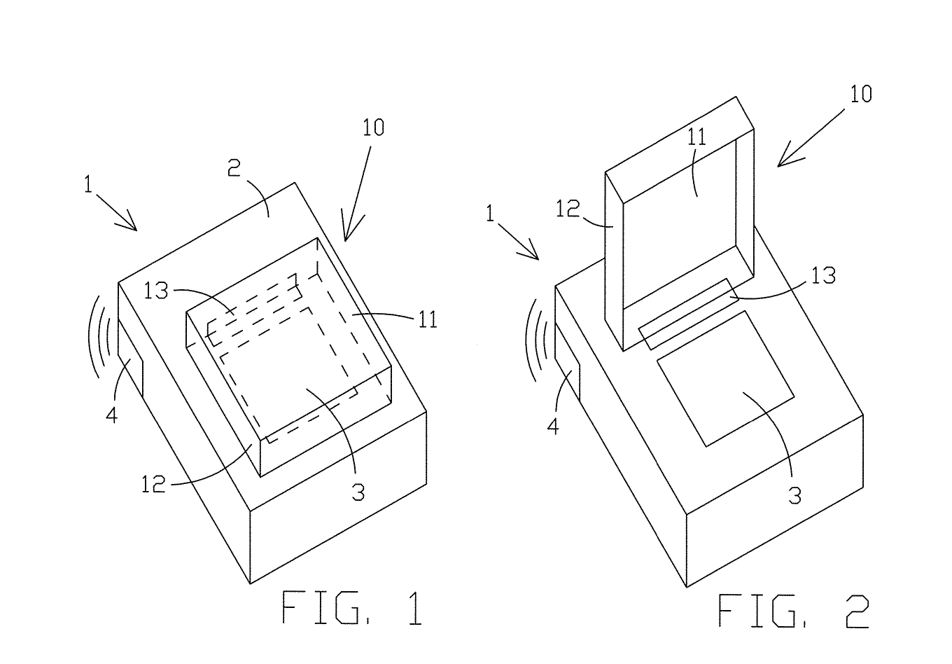

FIG. 1 shows a portable device 1 preferably of a rectangular parallelepiped shape and comprising, at a wall 2 (facing upwards in FIG. 1), a button 3 connected to an electronic circuit including an antenna 4 for the transmission of radio frequency electromagnetic waves. The latter are receivable by a first electronic apparatus which is preferably portable, i.e. an apparatus (not shown in the figures) the use of which does not place restrictions on the mobility of a user thereof. Portable electronic apparatuses include, by way of example, mobile phones, smartphones (i.e. mobile phones capable of performing certain functions typically performed by a computer), and compact laptops (that is, consisting of a parallelepiped body of small size and low weight). The connection between the device 1 and the portable electronic apparatus can be made, by way of example, by means of the known Bluetooth™ technology.

Pressing button 3 causes radio frequency waves coding an alarm signal to be sent by means of antenna 4. The recipient of the latter is a person who can access the electronic apparatus, either desk or portable, to which device 1 is connected. The alarm signal may consist, by way of example, of a text message or a sound message, for example a voice message. Therefore, antenna 4 acts as a means for emitting an alarm signal and button 3 acts as a means for activating the electronic circuit which controls antenna 4 so that the latter sends the alarm signal.

Alternatively or in addition to the above considerations, upon receipt of the alarm signal, the electronic apparatus to which to device 1 is connected may transmit the alarm signal to a second electronic apparatus, not necessarily portable, such as a so-called “desk” phone or a computer. This may take place, by way of example, through a cellular mobile network to which both the first and the second electronic apparatuses are connected. In this case, the recipient of the alarm signal is a person who can access the second electronic apparatus. If the latter is a computer, the alarm signal may be automatically managed by the aforesaid computer, by means of a communication to the police. The above considerations may be advantageous when the first portable electronic apparatus is held by the same person who holds device 1.

Incidentally, a portable electronic apparatus connectable to the cellular mobile network is an electronic apparatus preferably equipped with a SIM card by means of which the apparatus may connect to the Internet network (such as a mobile phone or a smartphone, for example). Alternatively, if the electronic apparatus is located in a geographical area having a Wi-Fi™ coverage, the connection of the apparatus to the cellular mobile network may take place wirelessly by means of a connection to a local network in turn connected to the cellular mobile network.

The interaction between device 1 and a first portable electronic apparatus, alternatively or in addition to being “direct”, may take place by means of a cellular mobile network to which both the device 1 and the first portable electronic apparatus are connected. In this case, the radio frequency waves emitted by antenna 4, instead of being receivable by the first portable electronic apparatus, are receivable by the cellular mobile network. The latter encodes the signal from device 1 into radio frequency waves and transmits it to the first portable electronic apparatus.

Incidentally, if device 1 is connectable to a cellular mobile network, the device 1, like a mobile phone or a smartphone, is preferably equipped with a SIM card by means of which it may connect to the Internet network. Advantageously, the alarm signal can thus be sent from device 1 to apparatuses also placed at a long distance from the device itself, and irrespective of the fact that the person holding device 1 also holds, by way of example, a mobile phone or a smartphone. Similarly to the above considerations, if device 1 lies in a geographical area having a so-called Wi-Fi™ coverage, the connection of device 1 to the cellular mobile network may take place wirelessly by means of a connection to a local network in turn connected to the cellular mobile network.

In addition to the above considerations, if device 1 is connectable to a cellular mobile network, the electronic apparatus with which device 1 may interact may not be portable. In other words, alternatively or in addition to being able to interact with a first portable electronic apparatus, device 1 may connect, by means of antenna 4, to any other electronic apparatus in turn connected to the cellular mobile network, such as a “desk” phone or a computer.

Device 1 may comprise a geolocator (not shown in the figures) for determining the geographical position of device 1 (e.g. by means of GPS technology). In this case, when button 3 is pressed, the geolocator acquires the geographical position of device 1. This information is then encoded into electromagnetic waves and included in the alarm signal transmitted by antenna 4. Thereby, the person or the computer receiving the alarm signal becomes aware of the place where device 1 is when button 3 is pressed.

As can be seen in FIG. 1, device 1 further comprises an element 10, preferably of a rectangular parallelepiped shape, and even more preferably a plate or a cap. The plate will be preferred when button 3 is embedded within parallelepiped 1. The cap is instead preferably used when button 3 protrudes outwards with respect to wall 2. Cap 10 comprises an upper base 11 and four side walls 12. In the configuration shown in FIG. 1, cap 10 is preferably arranged with base 11 parallel to wall 2 and rests on the latter at its side walls 12 so as to cover button 3. More precisely, the walls 12 delimit a region of wall 2 in which button 3 is fully comprised, so as to prevent the person holding device 1 from pressing button 3. At one of the side walls 12, cap 10 is preferably connected to wall 2 by means of a hinge 13 so as to be rotatable about an axis preferably parallel to wall 2. In particular, cap 10 is rotatable between at least a first position (shown in FIG. 1) in which cap 10 covers button 3 so as to prevent it from being pressed, and a second position (shown in FIG. 2) in which cap 10 allows button 3 to be pressed by the person holding device 1.

Cap 10 is a safety element which prevents button 3 from being inadvertently pressed. For sending an alarm signal, the person holding device 1 simply needs to rotate cap 10 to the second position to then press button 3. Device 1 preferably comprises a torsion spring (not shown in the Figures) which keeps cap 10 in the first position, opposing a rotation thereof from the first position to the second position.

FIG. 2 shows device 1 with the cap 10 rotated into the second position. The latter is preferably arranged with the base 11 orthogonal to wall 2.

If element 10 is a plate (not shown), the movement of the latter which allows the access to button 3 may be a sliding movement of the plate parallel to wall 2 or a rotation of the plate in a plane parallel to wall 2 about an axis perpendicular to said wall 2.

According to the description provided for a preferred embodiment, it is apparent that certain changes may be introduced by those skilled in the art without departing from the scope of the invention as defined by the following claims.

1. A portable device (1) comprising:
means (4) for emitting an alarm signal, said emitting means comprising means (4) for transmitting radio frequency electromagnetic waves coding said alarm signal;
means (3) for activating said emitting means (4) by a person holding said device (1);
wherein said transmitting means (4) are connectable to a portable receiving electronic apparatus.

2. (canceled)

3. A device (1) according to claim 1, wherein said transmitting means (4) are connectable to a cellular mobile network.

4. A device (1) according to claim 1, further comprising geolocation means of said device (1), said alarm signal including information on the geographical position of said device (1) when said emitting means (4) are activated.

5. A device (1) according to claim 1, further comprising means (10) for preventing said emitting means (4) from being activated.

6. A device (1) according to claim 5, wherein said activating means (3) comprise at least one button (3) placed at a wall (2) of said device (1).

7. A device (1) according to claim 5, wherein said preventing means (10) comprise at least one cap (10) and means (13) for moving said cap (10) between at least a first position at which said cap (10) prevents said button (3) from being pressed, and a second position at which said cap (10) allows said button (3) to be pressed.

8. A device (1) according to claim 7, further comprising elastic means which oppose a movement of said preventing means (10) from said first position to said second position.

9. A device (1) according to claim 7, wherein said moving means (13) comprise means (13) for rotating said cap (10) with respect to said wall (2).

10. A device (1) according to claim 8, wherein said elastic means comprise a torsion spring which opposes a rotation of said preventing means (10) from said first position to said second position.
